(19) United States
(12) Patent Application Publication
(10) Pub. No.: US 2009/0158028 A1
(43) Pub. Date: Jun. 18, 2009

(54) DRM METHOD AND DRM SYSTEM USING TRUSTED PLATFORM MODULE

(75) Inventors: Yungjoon JUNG, Daejeon-city (KR); Donghyouk Lim, Daejeon-city (KR); Youngbin Seo, Daejeon-city (KR); Yonggwan Lim, Daejeon-city (KR); Jaemyoung Kim, Daejeon-city (KR); Seungmin Park, Daejeon-city (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon-city (KR)

(21) Appl. No.: 12/172,728

(22) Filed: Jul. 14, 2008

(30) Foreign Application Priority Data
Dec. 17, 2007 (KR) 10-2007-0131989

(51) Int. Cl. H04L 9/00

(52) U.S. Cl. 713/155

(57) ABSTRACT

The present invention relates to a terminal apparatus including a trusted platform module (TPM) and a DRM method using the same. The terminal apparatus receives information on a validity period from a server, uses the TPM generates a public key including the information on the validity period, transmits the public key to the server, receives encoded digital contents from the server, and uses the TPM to decode the received digital contents.

### BACKGROUND OF THE INVENTION

1. Field of the Invention

The present invention relates to a DRM (digital right management) method and system for protecting the copyright of digital contents using a trusted platform module (TPM).

This work was supported by the IT R&D program of MIC/IITA [2006-S-039-02, Embedded Secure Operating System Technology Development].

2. Description of the Related Art

The development of processor technology leads to remarkable improvement in the performance of an embedded system, which enables a lot of systems to be connected to the outside through a network or by wireless communication. In addition, in recent years, apparatuses, such a PDA and a PMP, have used a general-purpose operating system, such as the Linux, and thus it is possible to provide an environment capable of executing external programs that are created by general users or other program creators. With a variation in the environment, security reinforcement becomes an essential function of the embedded operation system.

With the development of wire and wireless network techniques, security reinforcement in mobile apparatuses has also become important. In general, the existing mobile apparatus does not execute various application programs for various purposes, but is used for one purpose. However, with the rapid development of the performance of the mobile apparatus, the system environment of the mobile apparatus has been changed such that the mobile apparatus can use various application programs for various purposes. The downloading of digital contents becomes an essential function of the mobile apparatus with the development of the function of the mobile apparatus, which may cause an illegal copy of digital contents.

A server-based digital content protecting method has been used for the mobile apparatus in order to protect the copyright of digital contents. Specifically, information on a mobile apparatus is stored in a server, and the server generates proper DRM application contents on the basis of the information on the mobile apparatus before transmitting digital contents. In this case, the security system is likely to be disabled by the falsification of authentication information that is examined by the DRM. When authentication information is disclosed in a software manner, the security system is likely to be attacked due to the disclosed information.

### SUMMARY OF THE INVENTION

An object of the invention is to provide a digital right management (DRM) method and system using a trusted platform module (TPM), which is a hardware security module, in order to minimize the possibility of data being falsified in a software manner. The use of the TPM makes it possible to prevent the disclosure of important data and an illegal change in hardware, and protect an attack against the security system. As a result, it is possible to improve DRM security in a mobile apparatus.

According to an aspect of the invention, there is provided a DRM (digital right management) method using a terminal apparatus including a TPM (trusted platform module). The method includes: receiving information on a validity period from a server; using the TPM to generate a public key including the information on the validity period; transmitting the generated public key to the server; receiving encoded digital contents from the server; and using the TPM to decode the received digital contents.

The DRM method may further include, after the decoding of the digital contents, reproducing the decoded digital contents.

The DRM method may further include: after the receiving of the digital contents, checking the validity period of the digital contents; and determining whether to decode the digital contents.

According to another aspect of the invention, a DRM terminal apparatus includes: a DRM download unit that downloads digital contents from a server; and a TPM (trusted platform module) that generates a public key, and encodes or decodes digital contents. The DRM download unit downloads encoded digital contents from the server, and the TPM decodes the downloaded digital contents.

The DRM terminal apparatus may further include a digital content reproducing unit that reproduces the digital contents decoded by the TPM.

The DRM download unit may receive information on a validity period from the server before downloading the digital contents, and the TPM may generate a public key including the information on the validity period and transmits the public key to the server. The digital content reproducing unit may check the validity period of the digital contents and determine whether to decode the digital contents on the basis of the check result.

According to still another aspect of the invention, a DRM system includes: a DRM server; and a DRM terminal apparatus. The DRM server transmits information on a validity period to the DRM terminal apparatus, and also transmits encoded digital contents to the DRM terminal apparatus using a public key received from the DRM terminal apparatus. The DRM terminal apparatus includes a TPM, uses the TPM to generate a public key including the received information on the validity period, transmits the public key to the DRM server, and uses the TPM to decode the encoded digital contents received from the DRM server.

The DRM terminal apparatus may check the validity period of the digital contents and determine whether to decode the digital contents on the basis of the check result.

In the digital right management by software according to the related art, an illegal access is likely to elude a DRM routine by attacking an internal mechanism of software or data. However, the invention provides a TPM-based DRM method and system capable of preventing the disclosure of unique information of a terminal, which is important information, thereby improving security, and performing authentication and decoding processes in a hardware manner, thereby effectively reproducing digital contents.

### BRIEF DESCRIPTION OF THE DRAWINGS

FIG. 1 is a diagram illustrating the structure of a DRM system according to an embodiment of the invention;

FIG. 2 is a diagram illustrating the transmission of digital contents between a terminal apparatus and a server according to the embodiment of the invention; and

FIG. 3 is a flowchart illustrating a method of reproducing digital contents according to another embodiment of the invention.

### DESCRIPTION OF THE PREFERRED EMBODIMENTS

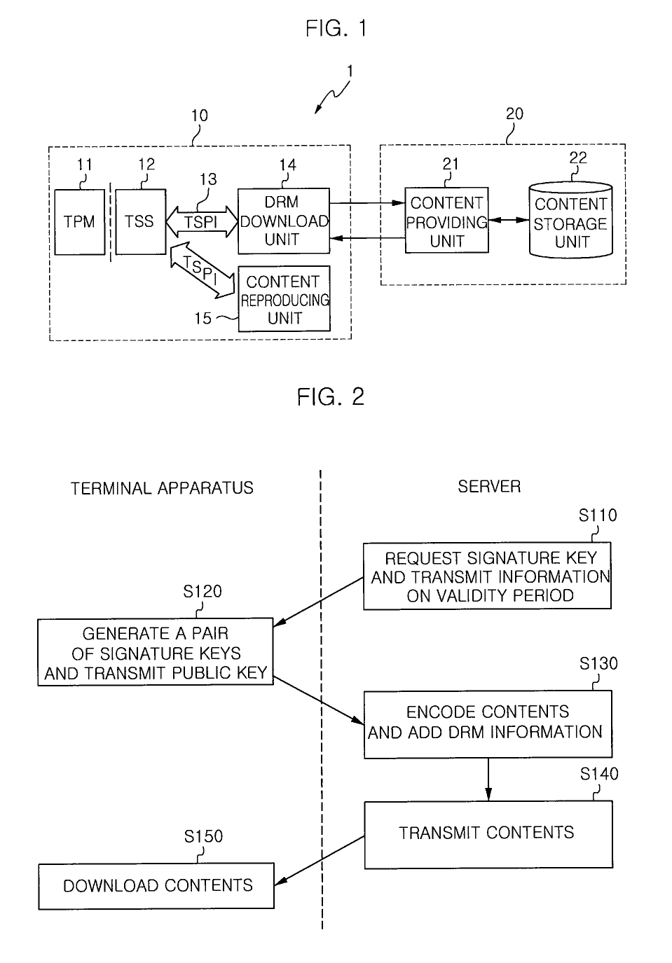

Hereinafter, a DRM system 1 according to an embodiment of the invention will be described with reference to FIG. 1.

The DRM system 1 includes a DRM terminal apparatus 10 and a DRM server 20.

The DRM terminal apparatus 10 downloads digital contents from the DRM server 20 and reproduces the digital contents. Examples of the DRM terminal apparatus 10 include a personal computer and various types of digital media players.

The DRM terminal apparatus 10 includes a DRM download unit 14 that downloads digital contents from the DRM server 20, a content reproducing unit 15 that reproduces the downloaded digital contents, a trusted platform module 11 (hereinafter, referred to as a TPM) that generates a public key to be transmitted to the DRM server and decodes the digital contents, and a TSS (TCPA software stack) that transmits data to the TPM through a TSP (TSS service provider) interface 13 (TSPI).

The TPM 11 is a module for providing a trusted platform in a hardware manner, and performs the generation of a public key and the encoding/decoding of data. The data is transmitted to another apparatus through the TSPI, and the TPM is described in detail in “http://developer.intel.com/design/mobile/platform/download s/trusted_platform_module_white_paper.pdf”.

The DRM server 20 includes a content providing unit 21 that transmits digital contents to the DRM terminal apparatus and a content storage unit 22 that encodes digital contents and stores the encoded digital contents.

A process of providing digital contents between the DRM terminal apparatus 10 and the DRM server 20 will be described in detail with reference to FIG. 2.

First, the DRM server 20 requests the DRM terminal apparatus 10 to transmit a signature key, and also transmits validity period information to the DRM terminal apparatus 10 (S110). The signature key is for encoding digital contents, and the validity period means an available period for which the DRM can use contents.

Then, the DRM terminal apparatus 10 generates a pair of signature keys such that the signature keys include the transmitted validity period information using the TPM, and transmits a public key of the generated pair of signature keys to the DRM server 20 (S120).

The DRM server 20 uses the public key to encode digital contents, and puts the DRM information into the digital contents. The DRM information may be added to the digital contents in the form of a DRM tag, and it may include information on the key used for a signature and information on the validity period (S130).

Then, the DRM server 20 transmits the encoded digital contents to the DRM terminal apparatus 10 (S140).

The DRM terminal apparatus 10 downloads digital contents from the DRM server (S150), decodes the downloaded digital contents, and reproduces the decoded contents.

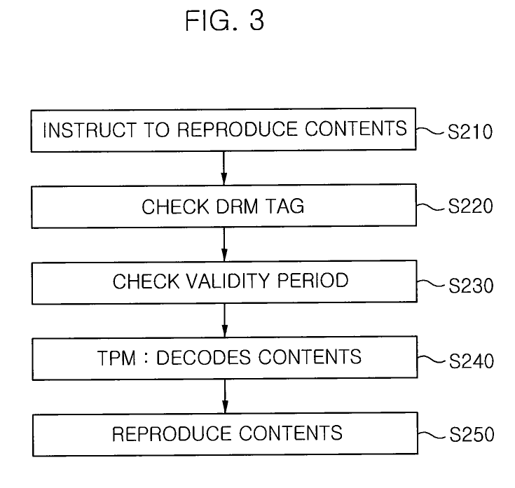

The operation of the DRM terminal apparatus 10 reproducing the downloaded digital contents will be described in detail with reference to FIG. 3.

When a user operates the DRM terminal apparatus 10 to input an instruction to reproduce digital contents (S210), first, the DRM terminal apparatus 10 checks the DRM tag included in the digital contents (S220). The DRM tag can authenticates the user on the basis of information on the signature key. The DRM terminal apparatus 10 sequentially checks additional information included in the DRM tag and the validity period of the digital contents (S230). When it is checked that the validity period of the digital contents has not expired, that is, when all authentication processes for the user succeed, the TPM 11 of the DRM terminal apparatus 10 decodes the digital contents (S240). The digital contents decoded by the TPM 11 are transmitted to the content reproducing unit 15, and the content reproducing unit 15 reproduces the digital contents (S250). In this case, the TPM may decode the digital contents in real time, and transmit the decoded digital contents to the content reproducing unit 15. Alternatively, the TPM may decode all the digital contents, and transmit the decoded digital contents to the content reproducing unit 15.

In the above-described embodiment, the digital contents are used as multimedia contents, but the digital contents may be other digital data, for example, documents. In this case, the content reproducing unit may be a document viewer.

The DRM terminal apparatus 10 can stably reproduce digital contents through the above-mentioned procedure, and the TPM, which is a hardware component, performs both the generation of the signature key and the decoding of digital contents. Therefore, it is possible to prevent an authorized person from acquiring digital contents from the system by using an illegal route, or by changing software. In addition, since the TPM decodes digital contents, it is possible to improve a decoding speed, and thus improve the efficiency of the real-time reproduction of digital contents.

Although the exemplary embodiment of the invention has been described above, the invention is not limited thereto. Various modifications and changes of the invention can be made without departing from the scope and spirit of the invention.

What is claimed is:

1. A DRM (digital right management) method using a terminal apparatus including a TPM (trusted platform module), the method comprising:
receiving information on a validity period from a server;
using the TPM to generate a public key including the information on the validity period;
transmitting the generated public key to the server;
receiving an encoded digital content from the server; and
using the TPM to decode the received digital content.

2. The DRM method of claim 1, further comprising:
after the decoding of the digital content, reproducing the decoded digital content.

3. The DRM method of claim 1, further comprising:
after the receiving of the digital content,
checking the validity period of the digital content; and
determining whether to decode the digital content.

4. The DRM method of claim 1, wherein
the digital content includes information on the validity period and information on the public key.

5. A DRM terminal apparatus comprising:
a DRM download unit that downloads a digital content from a server; and
a TPM (trusted platform module) that generates a public key, and encodes or decodes the digital content,
wherein the DRM download unit downloads the encoded digital content from the server, and
the TPM decodes the downloaded digital content.

6. The DRM terminal apparatus of claim 5, further comprising:
a digital content reproducing unit that reproduces the digital content decoded by the TPM.

7. The DRM terminal apparatus of claim 5,
wherein the DRM download unit receives information on a validity period from the server before downloading the digital content,
the TPM generates a public key including the information on the validity period and transmits the public key to the server, and
the digital content reproducing unit checks the validity period of the digital content and determines whether to decode the digital content on the basis of the check result.

8. The DRM terminal apparatus of claim 5, wherein
the digital content includes information on the validity period and information on the public key.

9. A DRM system comprising:
a DRM server; and
a DRM terminal apparatus,
wherein the DRM server transmits information on a validity period to the DRM terminal apparatus, and also transmits an encoded digital content to the DRM terminal apparatus using a public key received from the DRM terminal apparatus, and
the DRM terminal apparatus includes a TPM, uses the TPM to generate a public key including the received information on the validity period, transmits the public key to the DRM server, and uses the TPM to decode the encoded digital content received from the DRM server.

10. The DRM system of claim 9, wherein
the DRM terminal apparatus further includes a digital content reproducing unit that reproduces the digital content decoded by the TPM.

11. The DRM system of claim 9,
wherein the DRM terminal apparatus checks the validity period of the digital content and determines whether to decode the digital content on the basis of the check result.

12. The DRM system of claim 9, wherein
the digital content includes information on the validity period and information on the public key.
